(19) United States
(12) Patent Application Publication
(10) Pub. No.: US 2019/0220572 A1
(43) Pub. Date: Jul. 18, 2019

(54) DETECTION AND VISUALIZATION OF MUTATIONAL EVOLUTION DEPENDENT GENE SET ALTERATION

(71) Applicant: INTERNATIONAL BUSINESS MACHINES CORPORATION, ARMONK, NY (US)

(72) Inventors: Chaya LEVOVITZ, Manhattan, NY (US); Laxmi P. PARIDA, Mohegan Lake, NY (US); Kahn RHRISSORRAKRAI, Woodside, NY (US)

(21) Appl. No.: 15/872,035

(22) Filed: Jan. 16, 2018

(51) Int. Cl. G06F 19/14; G06F 19/22; G06F 19/26

(52) U.S. Cl. CPC G06F 19/14; G06F 19/26; G06F 19/22

(57) ABSTRACT

Embodiments include methods, systems, and computer program products for analyzing mutational evolution. Aspects include receiving a whole genome data set for a patient including a plurality of mutations. Aspects also include determining a variant allele frequency for each of the plurality of mutations. Aspects also include labeling each of the plurality of mutations with a gene set designation. Aspects also include constructing an evolution topology comprising an ordered representation of the plurality of mutations, wherein each of the plurality of mutations comprises one of the gene set designations.

### BACKGROUND

The present invention relates to analysis of mutational evolution, and more specifically, to detection and visualization of mutational evolution dependent gene set alteration.

Genetic sequencing has become an increasingly available technique for probing the basis for a variety of diseases and disorders. Whole-genome sequencing (WGS), which provides a nucleic acid sequence for a genome, and whole-exome sequencing (WES), which provides nucleic acid sequences of protein coding genes of the genome, can provide a wealth of information regarding the current and prior states of an organism or biological sample. Both the type and the number of genetic variants can vary across a population and over time within the population. Such variants can be studied to analyze the cause and evolutionary history of certain mutations to further the understanding of the basis of disease or genetic states.

### SUMMARY

In accordance with embodiments of the invention, a computer-implemented method for analyzing mutational evolution is provided. A non-limiting example of the method includes receiving, by a processor, a whole genome data set for a patient including a plurality of mutations. The method also includes determining, by the processor, a variant allele frequency for each of the plurality of mutations. The method also includes labeling, by the processor, each of the plurality of mutations with a gene set designation. The method also includes constructing, by the processor, an evolution topology including an ordered representation of the plurality of mutations, wherein each of the plurality of mutations includes one of the gene set designations.

In accordance with embodiments of the invention, a computer program product for analyzing mutational evolution is provided. The computer program product includes a computer readable storage medium readable by a processing circuit and storing program instructions for execution by the processing circuit for performing a method. A non-limiting example of the method includes receiving a whole genome data set for a patient including a plurality of mutations. The method also includes determining a variant allele frequency for each of the plurality of mutations. The method also includes labeling each of the plurality of mutations with a gene set designation. The method also includes constructing an evolution topology including an ordered representation of the plurality of mutations, wherein each of the plurality of mutations includes one of the gene set designations.

In accordance with embodiments of the invention, a processing system for analyzing mutational evolution includes a processor in communication with one or more types of memory. The processor is configured to perform a method. A non-limiting example of the method includes receiving a whole genome data set for a patient including a plurality of mutations. The method also includes determining a variant allele frequency for each of the plurality of mutations. The method also includes labeling each of the plurality of mutations with a gene set designation. The method also includes constructing an evolution topology including an ordered representation of the plurality of mutations, wherein each of the plurality of mutations includes one of the gene set designations.

### BRIEF DESCRIPTION OF THE DRAWINGS

This patent application contains at least one drawing executed in color. Copies of this patent application publication with color drawing(s) will be provided to the Office upon request and payment of the necessary fee. The subject matter of the present invention is particularly pointed out and distinctly claimed in the claims at the conclusion of the specification. The foregoing and other features and advantages of the one or more embodiments described herein are apparent from the following detailed description taken in conjunction with the accompanying drawings in which:

FIG. 1 is block diagram illustrating one example of a processing system for practice of the teachings herein;

FIG. 2 depicts charts chart illustrating aspects related to embodiments of the present invention;

FIG. 3 is a flow diagram illustrating a method for analyzing mutational evolution according to one or more embodiments of the present invention.

FIG. 4 depicts a diagram illustrating an exemplary system for analyzing mutational evolution according to one or more embodiments of the present invention;

FIG. 5 depicts a chart according to one or more embodiments of the present invention;

FIG. 6 depicts a chart according to one or more embodiments of the present invention;

FIG. 7 depicts a chart according to one or more embodiments of the present invention; and

FIG. 8 depicts a chart according to one or more embodiments of the present invention.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Genetic sequences are sought and studied in a variety of contexts and can provide information for the study of phenotype or traits of a population and/or of individuals within a population. Whole genome sequencing (WGS) is the determination of the complete DNA sequence of an organism's genome. Whole exome sequencing (WES) is the determination of the DNA sequence of protein coding genes in an organism's genome.

Analysis of genetic mutations can provide valuable information in the study of a variety of phenotypes, including inherited disorders and certain somatic diseases, such as cancer. A variant allele is a variant form of a gene at a particular position in its DNA sequence. Some genetic sequences vary from one individual to the next with no resultant affect, while others can result in dramatically different phenotypes. For example, a single mutation in a DNA sequence can alter the turning on or off of a gene or the functionality of a protein in a metabolic chain. Genetic data across a population in which genetic variability exists can provide insights not only into the relationship between a gene and a phenotype but also into the evolutionary history of a phenotype associated with a variant. For example changes in biological organs or systems that occur over time, such as kidneys, hair, or musculature changes, can be associated with somatic mutations.

Cancer, for instance, involves abnormal cell growth and is often associated with or caused by genetic mutations. In addition, the genetic material of a tumor or other cancerous tissue frequently acquires more mutations as the tumor grows. Whole-genome sequencing (WGS) and whole-exome sequencing (WES) of cancerous cells of tumor patients can inform of present and prior genetic states of cancerous tissue. Phylogenetics is the study of evolutionary relationships between biological entities. Genetic analysis of cancerous populations, for instance, has potential to reveal the basis for disease and/or for improved patient outcomes. Variant allele frequency (VAF), for example, can be used in some conventional genetic analyses to determine the age of a mutation within a tumor sample. Variant allele frequency (VAF), for example, can be used to estimate the age of a mutation within a tumor sample, whereby mutations with high VAFs are more likely to be older than mutations with low VAFs. In the case of cancer, due to the heterogeneity of intra- and inter-tumor samples, as well as patient-to-patient variability, widespread conservation of specific genetic mutations for a given phenotype is relatively low.

WGS and WES of biological samples of cancer patients can provide a wealth of information regarding the current state of a phenotype or condition, such as a tumor, and can also provide insight into its evolutionary history, yet only a fraction of relevant information can be harnessed and interpreted with conventional techniques.

Turning now to an overview of the aspects of the invention, one or more embodiments of the invention address the above-described shortcomings of the prior art by providing systems and methods that can identify the topological evolution of diseases and disorders having an evolving gene set, such as cancer. One or more embodiments of the invention can decode or decipher biological systems-related or biological pathway-related gene sets inherent to a given phenotype based at least in part upon phylogenetics. One or more embodiments of the invention can uncover novel biomarkers for a given phenotype and/or distinguish between categorical phenotypes, such as responsive versus non-responsive, using only WGS or WES data. Some embodiments of the invention can identify the presence of selection in mutational evolution based at least in part upon WGS or WES data.

By leveraging knowledge contained in gene sets, collections of genes giving rise to a common phenotype or function, it may be possible to computationally identify patterns of mutations across gene sets of multiple samples.

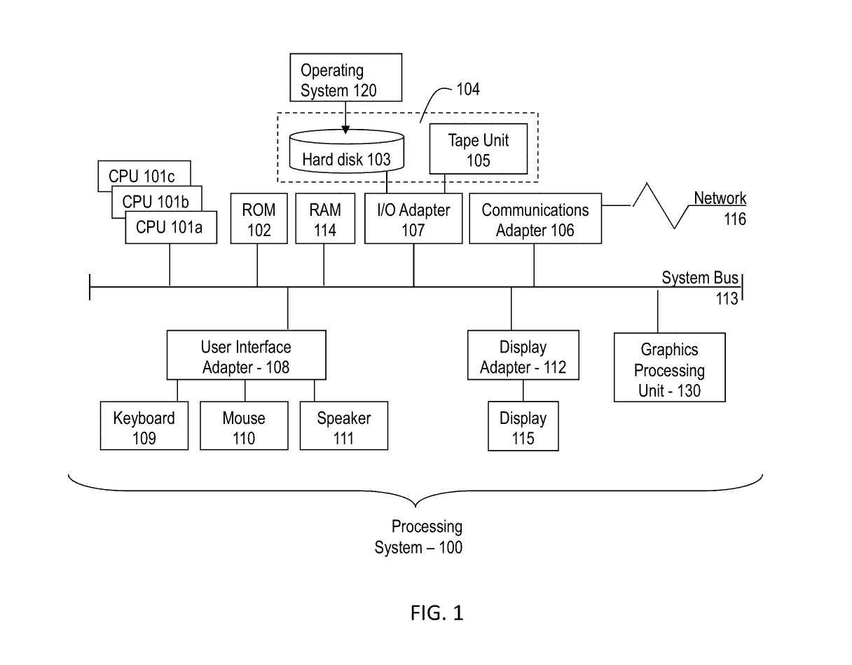

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 can include a reduced instruction set computer (RISC) microprocessor. Processors 101 are coupled to system memory 114 and various other components via a system bus 113. Read only memory (ROM) 102 is coupled to the system bus 113 and can include a basic input/output system (BIOS), which controls certain basic functions of system 100.

FIG. 1 further depicts an input/output (I/O) adapter 107 and a network adapter 106 coupled to the system bus 113. I/O adapter 107 can be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Software 120 for execution on the processing system 100 can be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which can include a graphics adapter to improve the performance of graphics intensive applications and a video controller. In one embodiment, adapters 107, 106, and 112 can be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which can include, for example, a Super I/O chip integrating multiple device adapters into a single integrated circuit.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

Turning now to technologies more specific to the instant disclosure, embodiments of the invention can provide convenient analysis of gene evolution. For a sample data set having no consistently mutated genes between phenotypes R and R′, conventional methods that look for over-represented genes between phenotypes are not suited to identify an association. Systems and methods according to embodiments of the invention can systematically identify patterns at the gene set level over the course of a phenotype's evolution.

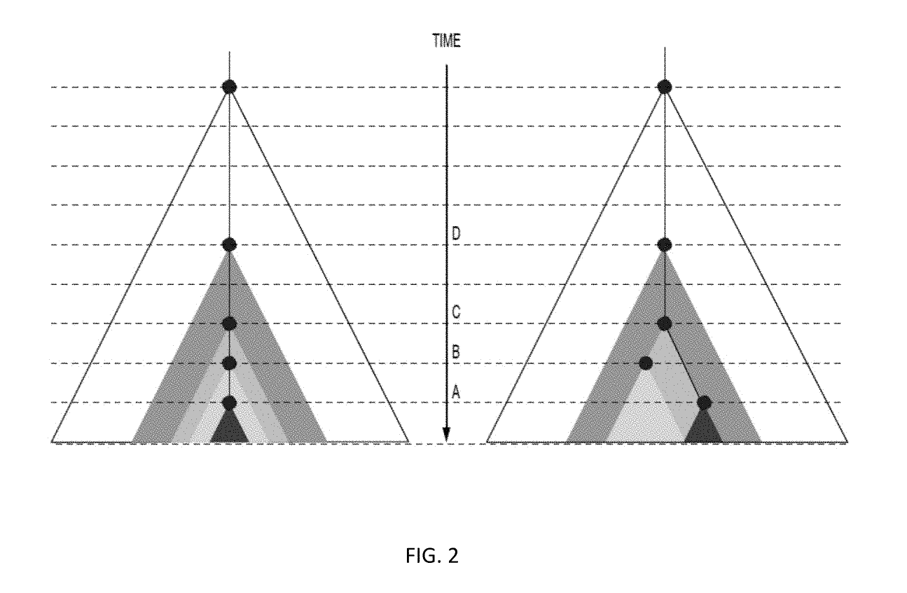

FIG. 2 depicts two potential exemplary tumor evolution trees for a dataset with variant allele frequencies of 1/9:2/9:3/9:5/9 corresponding to mutations a, b, c, and d respectively. The time of each mutation can be estimated by the relative allele frequencies. As is shown in FIG. 2, for instance, d is the earliest mutation. In the left-hand panel of FIG. 2, mutation a directly descends from mutation b whereas in the right-hand panel, mutations a and b each descend from mutation c and are not directly related to each other. As stated above, d has the highest VAF. However, without further information, it is not possible to distinguish between the two evolutionary scenarios depicted in FIG. 2. Specifically, with VAF alone, it is not possible to deduce whether or not mutations a and b are seen together, which could distinguish between the tumor evolution trees depicted in FIG. 2.

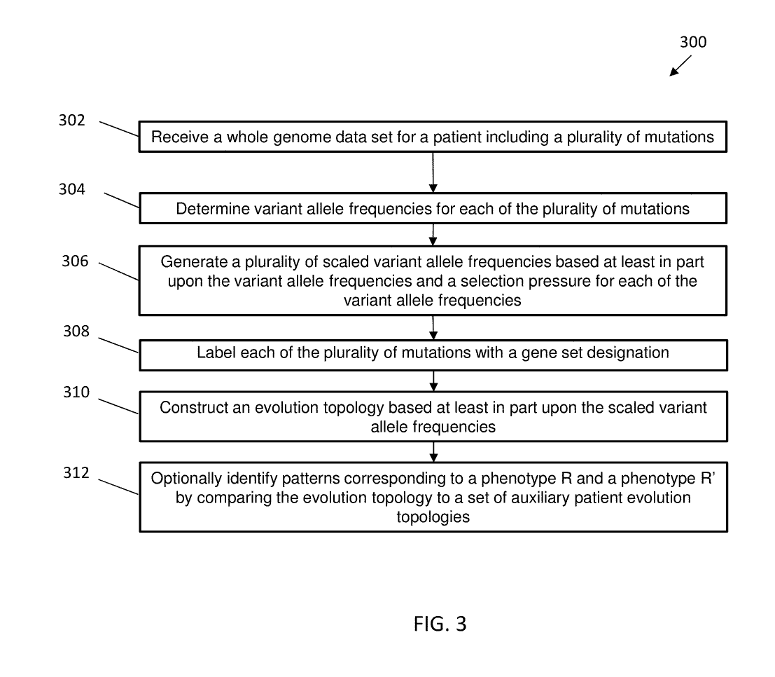

Referring now to FIG. 3, a flow chart illustrating an exemplary method 300 for analyzing mutational evolution according to one or more embodiments of the present invention is shown. According to the method, a whole genome data set for a patient including a plurality of mutations is received, as shown at block 302. The method also includes, as shown at block 304, determining VAFs for each of the plurality of mutations. Determining VAF can include determining a list L of possible alleles a, b, c, n and, based upon the list of possible alleles and the whole genome data set for a patient pᵢ, determining for patient pᵢ the observed allele frequencies fᵢ₁ of alteration a₁. The method 300 also includes, as shown at block 306, generating a plurality of scaled variant allele frequencies based at least in part upon the variant allele frequencies and a selection pressure for each of the variant allele frequencies. The method also includes, as shown at block 308, labeling each of the plurality of mutations with a gene set designation. The method 300 also includes, as shown at block 310, constructing an evolution topology based at least in part upon the scaled variant allele frequencies. The method 300 also includes, as shown at block 312, optionally identifying patterns corresponding to a phenotype R and a phenotype R′ by comparing the evolution topology to a set of auxiliary patient evolution topologies. The auxiliary patient evolution topologies can include any set of evolution topologies generated according to embodiments of the invention for a plurality of patients to which the evolution topology is sought to be compared. The auxiliary patient evolution topologies, for example, can correspond to patients with similar or the same medical condition or status or with the same or similar demographic or geographic status.

Embodiments of the invention include labeling each of the plurality of mutations with a gene set designation. Gene set designations include designations or classifications based upon a pathway or geneset membership. Databases including pathway and geneset data are known.

Gene sets can include collections or lists of genes associated with an attribute. For example, a gene set can include known genes associated with a biological pathway, a set of genes associated with similar expression patterns, phenotypes, biological functions, chromosomal locations, or regulation mechanisms.

Gene sets can be identified from collections of gene sets C=[G₁, G₂, . . . G_{N}] and can be accessed in accordance with embodiments of the invention, including for example the Kyoto Encyclopedia of Genes and Genomes (KEGG), Reactome Pathway Database, Protein Analysis through Evolutionary Relationships (PANTHER) system, and/or Gene Ontology, including for instance cytogenetic sets, functional sets, regulatory-motif sets, and/or neighborhood sets. In some embodiments of the invention, it is assumed that gene sets are non-overlapping. A geneset designation can include, in some embodiments of the invention, a textual identification. A geneset designation can include, in some embodiments of the invention, a visual identification, such as a pattern or color that is defined to correspond to a geneset.

In some embodiments of the invention, scaled VAFs are generated. A scaled VAF can be generated based, at least in part, upon the VAFs and a selection pressure for each of the VAFs. The selection pressure can be determined by differential weighting of alterations. For example, for each alteration a₁, a selection value S₁, where −1<S₁<1 such that a value of 0 indicates no selection, a positive value indicates the observed frequency of the allele is relatively low and a negative value indicates the observed frequency is relatively high. The scaled VAF can include an effective allele frequency f′ᵢ₁ determined according to formula for each alteration and for every patient:

f′ᵢ₁=(1+s₁)fᵢ₁

Some embodiments of the invention include constructing an evolution topology based at least in part upon the scaled variant allele frequencies. The evolution topology can include an ordered list of geneset designations, wherein the order is based at least in part upon the VAF and/or the scaled VAF. In some embodiments of the invention, the evolution topology includes a bead plot as described herein.

In some embodiments of the invention, mutations are combined prior to construction of the evolution topology to reduce data dimensionality. For example, a plurality of similar gene sets can be binned to reduce the overall number of geneset designations in an evolution topology.

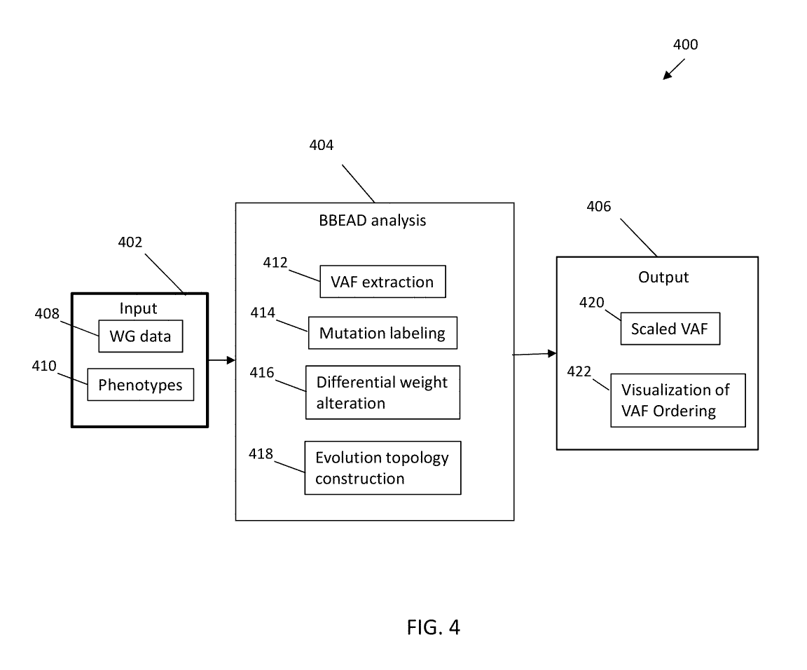

FIG. 4 depicts an exemplary system 400 for analyzing mutational evolution according to one or more embodiments of the invention. The system 400 includes an input 402, a BBEAD analysis module 404, and an output 406.

The input 402 can include, for instance, whole genome data 408. The input 402 can also include phenotypes 410. Whole genome data 408 can include any dataset with mutation information at the gene-level. Methods of acquiring genomic data are known and are not limited by the methods herein. An organism can include, for example, a human, animal, bacteria, fungus, or plant. In some embodiments, the organism is a human. The genomic data can include genomic data for a plurality of organisms, such as a plurality of humans or human patients. In some embodiments, the genomic data is obtained from a known or public collection of data or from combinations of sources. For example data can be obtained from independent patient sets.

Sample phenotypes R and R′ can correspond to two phenotypes. R and R′ can include any pair of phenotypes of interest. In some embodiments, R corresponds to responsiveness to a treatment and R′ corresponds to non-responsiveness to a treatment. R and R′ can correspond to any pair of phenotypes. In some embodiments, R and R′ are mutually exclusive attributes.

The BBEAD analysis module 404 can include a variant allele frequency (VAF) extraction engine 412. The VAF extraction engine 412 can determine VAFs for a plurality of mutations in genomic data. The BBEAD analysis module 404 can also include a mutation labeling engine 414. The mutation labeling engine 414 can label mutations with a gene set designation, such as a color or a pattern associated with a gene set. The BBEAD analysis module 404 can also include a differential weight alteration engine 416. The differential weight alteration engine 416 can scale the VAFs based at least in part upon a selection pressure for the VAFs. The BBEAD analysis module 404 can also include an evolution topology construction engine 418. The evolution topology construction engine 418 can generate evolution topologies, such as bead plots.

The output 406 can include a scaled VAF 420. The output 406 can also include a visualization of VAF ordering 422. In some embodiments of the invention, the output includes an evolution topology including a bead plot. In some embodiments of the invention the bead plot includes a plurality of beads, or colored dots, wherein each colored bead represents a variant that is colored according to its gene set membership. In some embodiments of the invention, the bead plot includes beads positioned according to their VAF rank order. In some embodiments of the invention, the bead plot includes beads positioned according to their VAF rank order.

As described above, in some embodiments of the invention, the method includes comparing evolution topologies for a plurality of patients to identify patterns corresponding to R and R′ phenotypes. For example, in some embodiments of the invention, an evolution topology is constructed such that a gene set designation includes a plurality of beads representing variants that are colored according to their gene set membership.

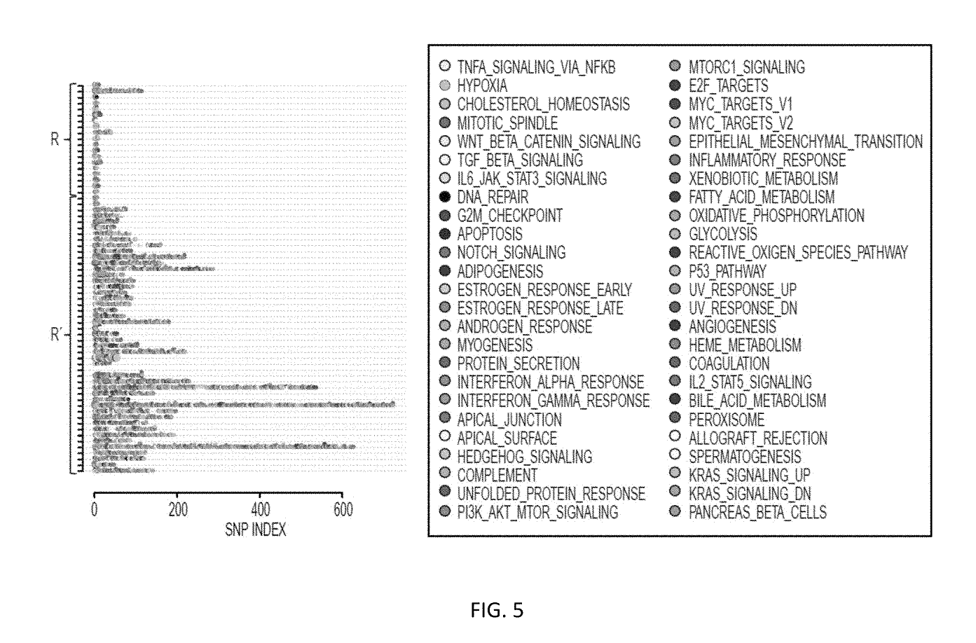

One such exemplary evolution topology according to embodiments of the invention is depicted in FIG. 5. FIG. 5 represents a bead plot of all gene sets from the MSigDB Hallmark gene set collection charted as SNP index versus R and R′ in the context of examining tumor evolution. Variants in the plot colored according to gene set membership and are ordered by decreasing VAF and positioned by their VAF rank order. As is illustrated, where a gene belongs to multiple gene sets, a plurality of beads can be stacked at the same VAF position and colored accordingly. As can be seen in FIG. 5, the evolution topology visually reveals the differences in the number of variants as well as the VAF for R and R′, shown on the y-axis.

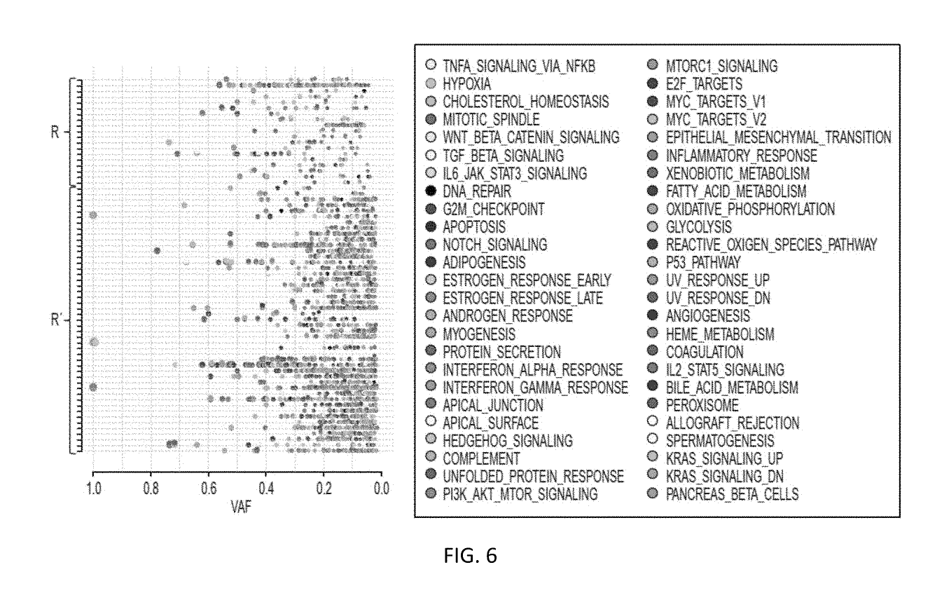

FIG. 6 illustrates another exemplary visualization for mutational evolution analysis according to one or more embodiments of the present invention. FIG. 6 represents a bead plot of all gene sets from the MSigDB Hallmark gene set collection charted as SNP index versus R and R′. Variants in the plot colored according to gene set membership and are ordered by decreasing VAF and positioned by their VAF.

In some embodiments of the invention, a plurality of gene sets are included in one bead plot. In some embodiments of the invention, one gene set is included in one bead plot.

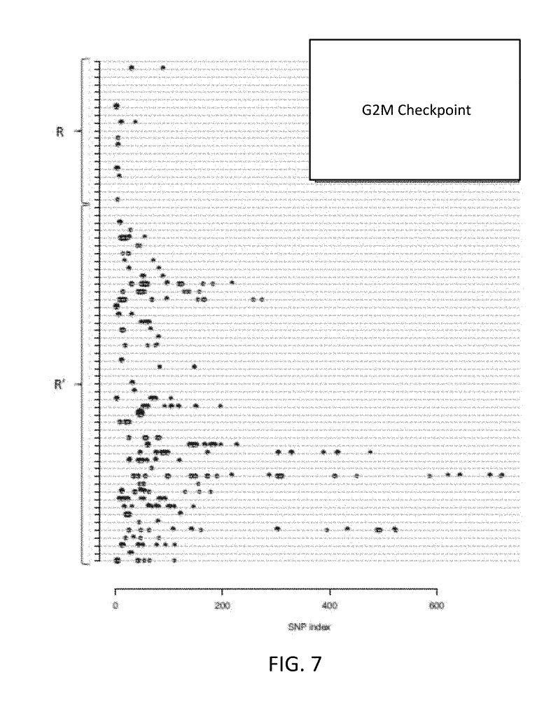

FIG. 7 illustrates another exemplary visualization for mutational evolution analysis according to one or more embodiments of the present invention. FIG. 7 represents an exemplary bead plot of one gene set, the G2M Checkpoint gene set, from the MSigDB Hallmark gene set collection gene set collection charted as SNP index versus R and R′. Variants in the plot can be colored according to gene set membership, as in FIG. 5, and are ordered by decreasing VAF and positioned by their VAF rank order. As can be seen in FIG. 5, the evolution topology can visually reveal differences in the number of variants as well as the VAF for R and R′, shown on the y-axis.

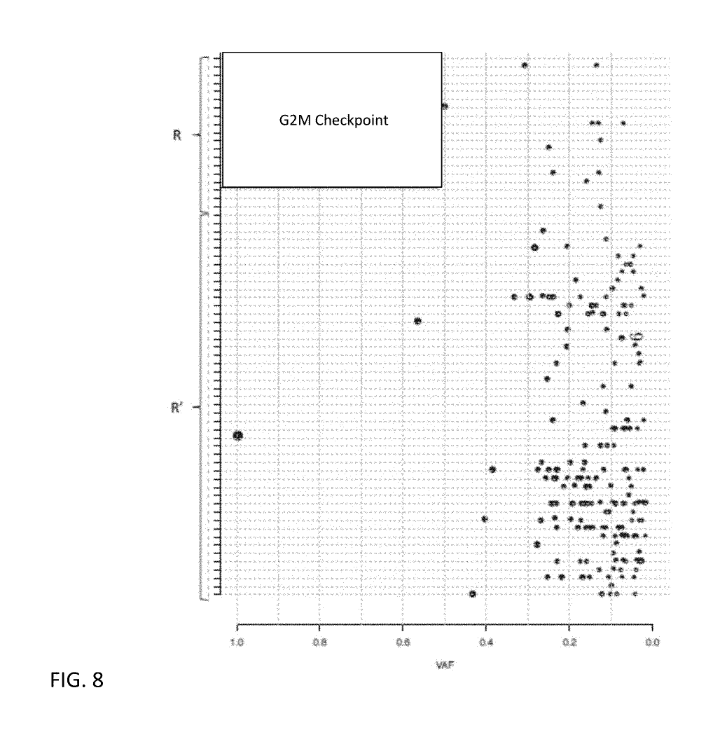

FIG. 8 illustrates another exemplary visualization for tumor evolution analysis according to one or more embodiments of the present invention. FIG. 8 represents the gene set used to generate FIG. 7, wherein the variants in the plot are positioned by their VAF.

Embodiments of the invention can provide a number of advantages relative to conventional methods of analyzing mutational evolution. Embodiments of the invention allow visual interpretation of large amounts of VAF data in connection with analysis of mutational evolution to assist with identifying relevant mutational associations. In some embodiments of the invention, gene set-specific extraction can be performed from whole genome data of multiple patients. Embodiments of the invention advantageously integrate phylogenetic data with pathway and gene set analysis. Methods and systems according to embodiments of the invention generate data transformations that can provide visualizations that are comprehensible to researchers and clinicians that would otherwise be uninterpretable.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments of the invention, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments of the invention, the practical application, the technical improvement over technologies found in the marketplace, or to enable others of ordinary skill in the art to understand the embodiments described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form described. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There can be many variations to this diagram or the steps (or operations) described therein without departing from the spirit of embodiments of the invention. For instance, the steps can be performed in a differing order or steps can be added, deleted or modified. All of these variations are considered a part of the claimed invention.

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for analyzing mutational evolution, the method comprising:
receiving, by a processor, a whole genome data set for a patient comprising a plurality of mutations;
determining, by the processor, a variant allele frequency for each of the plurality of mutations;
labeling, by the processor, each of the plurality of mutations with a gene set designation; and
constructing, by the processor, an evolution topology comprising an ordered representation of the plurality of mutations, wherein each of the plurality of mutations comprises one of the gene set designations.

2. The computer-implemented method of claim 1, wherein the gene set designation comprises a visual label corresponding to a gene set.

3. The computer-implemented method of claim 2, wherein the gene set designation comprises a color corresponding to a gene set.

4. The computer-implemented method of claim 1 further comprising generating a plurality of scaled variant allele frequencies based at least in part upon a selection pressure for each of the variant allele frequencies.

5. The computer-implemented method of claim 1 further comprising combining some of the plurality of mutations into a bin, and wherein labeling the plurality of mutations with the gene set designation comprises labeling the bin with the gene set designation.

6. The computer-implemented method of claim 1, wherein constructing the ordered representation of the plurality of mutations comprises ordering each of the mutations by an associated scaled variant allele frequency.

7. The computer-implemented method of claim 1 further comprising comparing the evolution topology to a set of auxiliary patient evolution topologies and identifying patterns corresponding to a phenotype R and a phenotype R′ based at least in part upon the comparison.

8. The computer-implemented method of claim 1, wherein the evolution topology comprises a tumor evolution topology.

9. A computer program product for analyzing mutational evolution, the computer program product comprising:
a computer readable storage medium readable by a processing circuit and storing program instructions for execution by the processing circuit for performing a method comprising:
receiving a whole genome data set for a patient comprising a plurality of mutations;
determining a variant allele frequency for each of the plurality of mutations;
labeling each of the plurality of mutations with a gene set designation; and
constructing an evolution topology comprising an ordered representation of the plurality of mutations, wherein each of the plurality of mutations comprises one of the gene set designations.

10. The computer program product of claim 9, wherein the gene set designation comprises a visual label corresponding to a gene set.

11. The computer program product of claim 10, wherein the gene set designation comprises a color corresponding to a gene set.

12. The computer program product of claim 9, wherein the method further comprises generating a plurality of scaled variant allele frequencies based at least in part upon a selection pressure for each of the variant allele frequencies.

13. The computer program product of claim 9, wherein the method further comprises combining some of the plurality of mutations into a bin, and wherein labeling the plurality of mutations with the gene set designation comprises labeling the bin with the gene set designation.

14. The computer program product of claim 9, wherein constructing the ordered representation of the plurality of mutations comprises ordering each of the mutations by an associated scaled variant allele frequency.

15. The computer program product of claim 9 wherein the method further comprises comparing the evolution topology to a set of auxiliary patient evolution topologies and identifying patterns corresponding to a phenotype R and a phenotype R′ based at least in part upon the comparison.

16. A processing system for analyzing mutational evolution, comprising:
a processor in communication with one or more types of memory, the processor configured to perform a method comprising:
receiving a whole genome data set for a patient comprising a plurality of mutations;
determining a variant allele frequency for each of the plurality of mutations;
labeling each of the plurality of mutations with a gene set designation; and
constructing an evolution topology comprising an ordered representation of the plurality of mutations, wherein each of the plurality of mutations comprises one of the gene set designations.

17. The processing system of claim 16, wherein the gene set designation comprises a visual label corresponding to a gene set.

18. The processing system of claim 16, wherein the method further comprises generating a plurality of scaled variant allele frequencies based at least in part upon a selection pressure for each of the variant allele frequencies.

19. The processing system of claim 16, wherein the method further comprises combining some of the plurality of mutations into a bin, and wherein labeling the plurality of mutations with the gene set designation comprises labeling the bin with the gene set designation.

20. The processing system of claim 16, wherein constructing the ordered representation of the plurality of mutations comprises ordering each of the mutations by an associated scaled variant allele frequency.
